(19) United States
(12) Patent Application Publication
(10) Pub. No.: US 2005/0059343 A1
(43) Pub. Date: Mar. 17, 2005

(54) Apparatus and method for identifying a gap filler in a satellite broadcasting system

(75) Inventor: Kyung-Ha Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/901,679

(22) Filed: Jul. 29, 2004

(30) Foreign Application Priority Data
Jul. 29, 2003 (KR) 52341/2003

(51) Int. Cl. H04B 7/185

(52) U.S. Cl. 455/12.1; 455/3.02

(57) ABSTRACT

A gap filler for transmitting satellite broadcasting data received from a broadcasting satellite to a mobile receiver in a satellite broadcasting system is provided and method thereof. In the gap filler, a satellite tuner demodulates the received satellite broadcasting signal and outputs the demodulated satellite broadcasting signal, a frame constructer forms frames by modulating the demodulated satellite broadcasting signal, and inserting a gap filler ID into a control channel frame, and a radio processor transmits the frames received from the frame constructer at a radio frequency.

### PRIORITY

This application claims the benefit under 35 U.S.C. § 119(a) of an application entitled “Apparatus and Method for Identifying Gap Filler in a Satellite Broadcasting System” filed in the Korean Intellectual Property Office on Jul. 29, 2003 and assigned Ser. No. 2003-52341, the entire contents of which are incorporated herein by reference.

### BACKGROUND OF THE INVENTION

1. Field of the Invention

The present invention relates generally to a satellite Digital Multimedia Broadcasting (DMB) apparatus and method. In particular, the present invention relates to an apparatus and method for identifying a plurality of gap fillers.

2. Description of the Related Art

A typical DMB system will be described below with reference to FIG. 1.

Referring to FIG. 1, a base station 200 transmits multimedia broadcasting information received from a contents provider 100 to a broadcasting satellite 300. The broadcasting satellite 300 serves as a relay for transmitting the multimedia broadcasting signal to a terminal 500A. That is, the broadcasting satellite 300 multiplexes the received multimedia broadcasting information using Code Division Multiplex (CDM) and transmits the CDM signal directly to the terminal 500A at a frequency of 2.6 GHz. To allow terminals such as a terminal 500B to receive the multimedia broadcasting signal inside buildings or in shadow areas which are areas the signal cannot reach from the broadcasting satellite 300, the broadcasting satellite 300 multiplexes the multimedia broadcasting signal using Time Division Multiplex (TDM) and transmits the TDM signal to a plurality of gap fillers 400 at a frequency of 11 GHz.

A gap filler 400 converts the TDM signal to a 2.6-GHz CDM signal and transmits the CDM signal to the terminal 500B in a shadow area within the terminal 500B's service area 10. The service area 10 may also comprise a shadow area or an overlap area.

Since all the gap fillers forward the signal received from the broadcasting satellite 300 to the terminal 500, the terminal 500B may be located in an overlap area where it can receive the signal from a plurality of gap fillers. FIG. 2 illustrates a terminal placed in an overlap area where it receives signals from a plurality of gap fillers along a plurality of paths.

Referring to FIG. 2, the terminal receives a signal from gap filler A along two paths, from gap filler B along three paths, and from gap filler C along one path. The terminal located in an overlap area cannot identify the gap fillers from which it has received the signals along the six paths.

In the above situation, the following problems are faced.

(1) If the terminal cannot determine which gap filler has transmitted a signal and cannot measure the power of the received signal, it is difficult to optimize the positioning and transmit power of the gap filler. Installation of an appropriate number of gap fillers at appropriate positions greatly affects reception quality and cost. Even the transmit power of existing gap fillers must be optimized to thereby minimize shadow areas and reduce interference between the gap fillers. However, the optimization is limited unless the terminal identifies respective gap fillers that transmitted the signals.

(2) Regarding receive diversity through a rake receiver, combining signals from as many gap fillers as possible contributes to performance improvement, if the power of the received signals is at or above a predetermined threshold. For example, when the terminal can receive signals from three paths at the same time and, as illustrated in FIG. 2, it receives signals from three gap fillers along a plurality of paths, considering the mobility of the terminal, it is preferred to select one path from each of the three gap fillers, rather than to select three paths from the same gap filler. However, if the terminal fails to identify the gap filler from which a particular path is established and measures just the received signal strength of the path, path assignment in the rake receiver is performed according to the received signal strengths. Consequently, it is difficult to achieve an optimum diversity of combining paths from a plurality of gap fillers in the terminal.

Korean Patent Publication No. 2003-0036540, which was filed to overcome the problem, proposes a method of transmitting from a gap filler to a terminal a gap filler identifier (ID) and additional service information using one unused Walsh code. However, the disclosure has the following problems.

(1) As each physical channel is added, channel interference increases, thereby reducing reception quality. In satellite DMB, each channel is identified by a Walsh code. Yet, considering that the addition of a broadcasting channel greatly affects reception performance at a receiver due to unstable orthogonality and multipath interference, the decreased reception quality may be of importance.

(2) If a gap filler transmits ID information as proposed in the above document, the terminal must demodulate the Walsh code of a corresponding channel to detect corresponding gap filler ID information. This makes the structure of the terminal complex.

### SUMMARY OF THE INVENTION

An object of the present invention is to substantially solve at least the above problems and disadvantages and to provide at least the advantages below. Accordingly, an object of the present invention is to provide an apparatus and method for identifying gap fillers that have transmitted multipath signals to a terminal capable of receiving a Digital Multimedia Broadcasting (DMB) service.

Another object of the present invention is to provide an apparatus and method for optimizing the positioning and transmit power of gap fillers by allowing a mobile receiving terminal to measure mutual interference and shadow areas of signals transmitted by gap fillers.

It is a further object of the present invention to provide an apparatus and method for minimizing a performance decrease caused by an environmental change by allowing a receiving terminal to combine signals from a plurality of gap fillers.

The above objects are achieved by providing a gap filler identifying apparatus and method in a satellite broadcasting system.

According to one aspect of the present invention, in a gap filler for transmitting satellite broadcasting data received from a broadcasting satellite to a mobile receiver in a satellite broadcasting system, a satellite tuner demodulates the received satellite broadcasting signal and outputs the demodulated satellite broadcasting signal, a frame constructer forms frames by modulating the demodulated satellite broadcasting signal, and inserting a gap filler ID into a control channel frame, and a radio processor transmits the frames received from the frame constructer at a radio frequency.

According to another aspect of the present invention, in a receiver for receiving a signal from a gap filler in a satellite broadcasting system, a finger processor demodulates signals received from paths having received signal strengths at or above a predetermined threshold and outputs the demodulated symbols, and a gap filler ID detector detects a gap filler ID from the demodulated symbols.

According to a further aspect of the present invention, in a method of converting satellite broadcasting data received from a broadcasting satellite and transmitting the converted satellite broadcasting data to a mobile receiver in a satellite broadcasting system, the satellite broadcasting signal is received and demodulated. Frames are formed by modulating the demodulated satellite broadcasting signal, and inserting a gap filler ID into a control channel frame, and transmitted at a radio frequency.

According to still another aspect of the present invention, in a method of identifying gap fillers from a received signal in a satellite broadcasting system, superframe synchronization is acquired by demodulating a control channel received from a gap filler, multipath components are searched for timing at which initial synchronization is acquired and selecting paths having received signal strengths, a value corresponding to a gap filler ID in the control channel starting from the start point of a superframe is accumulated for each of the selected paths, gap filler IDs are detected from the accumulated values, and based on the detected gap filler IDs, paths having large received signal strengths among paths from a gap filler which is not assigned currently are assigned first.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating the configuration of a conventional satellite Digital Multimedia Broadcasting (DMB) system;

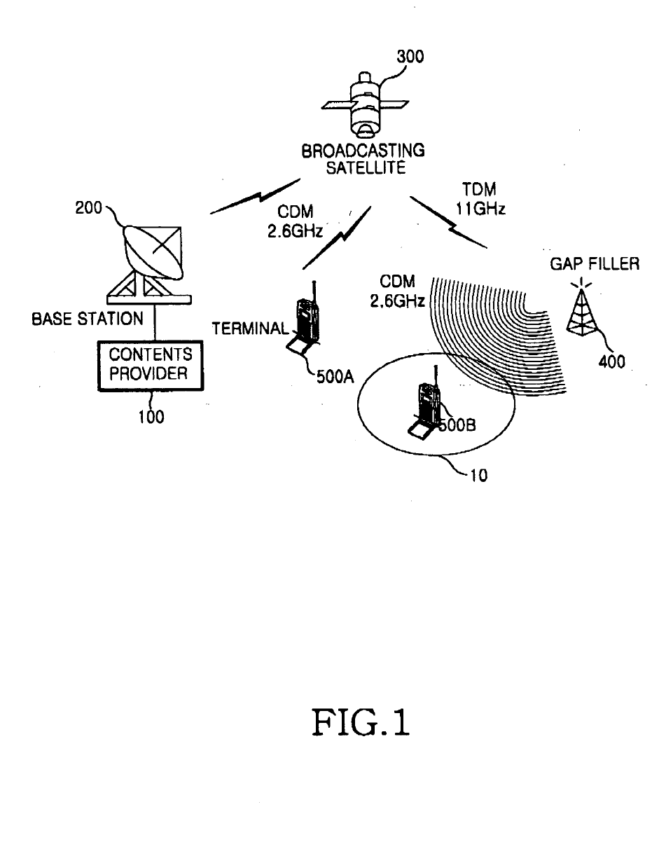

FIG. 2 is a diagram illustrating an overlap area in which a receiving terminal receives signals from a plurality of gap fillers along a plurality of paths;

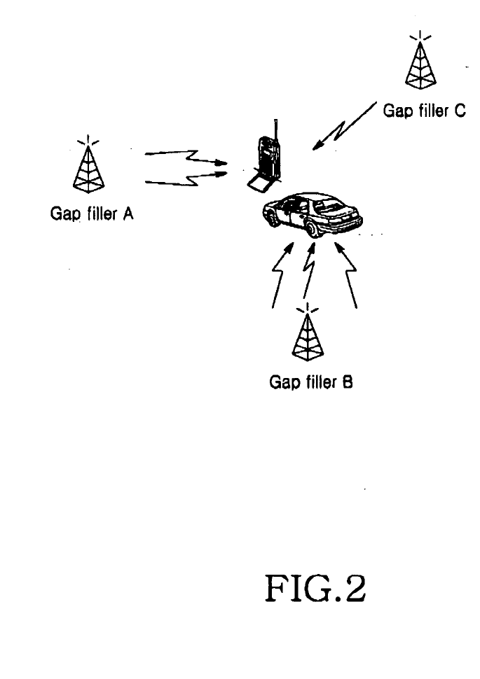

FIG. 3 is a block diagram illustrating a gap filler according to an embodiment of the present invention;

FIG. 4 is a diagram illustrating a format of a pilot channel frame;

FIG. 5 is a block diagram of a satellite receiving terminal; and

FIG. 6 is a flowchart illustrating the operation of the satellite receiving terminal according to an embodiment of the present invention.

Throughout the drawings, it should be noted that the same or similar elements are denoted by like reference numerals.

### DETAILED DESCRIPTION OF THE PREFERRED EMBODIMENT

An embodiment of the present invention will now be described herein below with reference to the accompanying drawings. In the following description, well-known functions or constructions are omitted for conciseness.

The embodiment of the present invention provides a gap filler identifying apparatus and method in which a gap filler inserts gap filler ID information onto a control channel in an existing frame and transmits the modified frame to a terminal so that the terminal can identify the gap filler that has transmitted the signal.

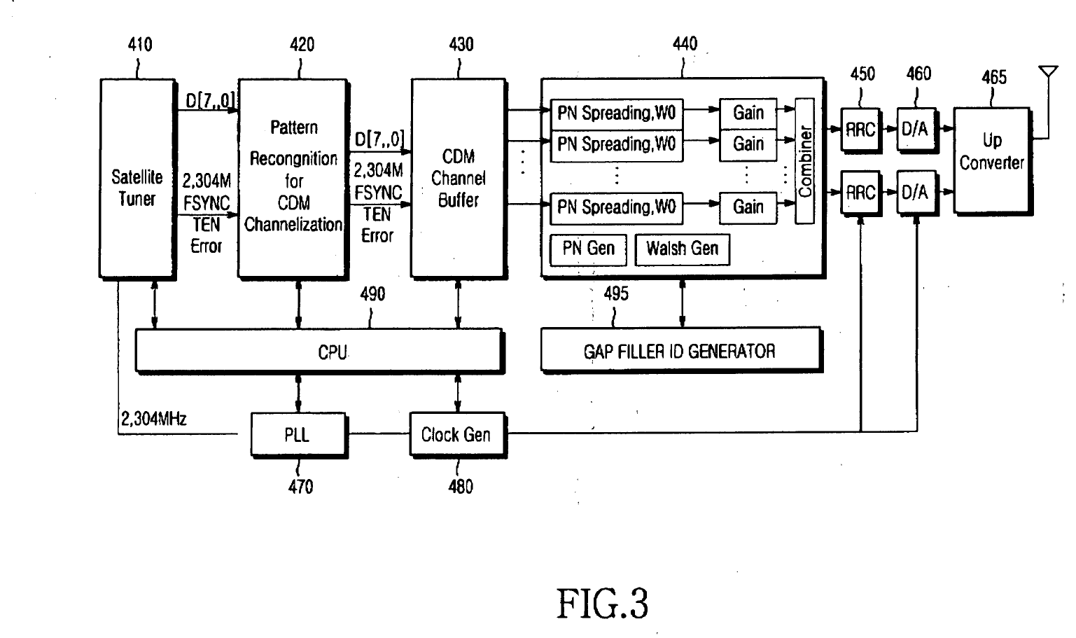

FIG. 3 is a block diagram of a gap filler according to an embodiment of the present invention.

Referring to FIG. 3, signal processing in the gap filler involves demodulation of a Time Division Multiplex (TDM) signal and modulation of a Code Division Multiplex (CDM) signal with TDM-to-CDM conversion in-between. A TDM frame is basically 25.5 msec in duration, including two basic 12.75-msec CDM frames. One TDM signal is transmitted at a time, whereas a plurality of CDM signals can be transmitted at the same time. Therefore, a TDM signal received for 25.2 msec can be divided into two channels and transmitted as CDMA signals for 12.75 msec.

A total of 32 25.5-msec frames are multiplexed in TDM and transmitted by a satellite. The gap filler detects the boundary between superframes in the received TDM data, separates a 25.5-msec pilot channel and 25.5-msec broadcasting channels from the TDM data, modulates the separated channels into CDM signals, and transmits them.

A satellite tuner 410 receives and demodulates a TDM signal from the broadcasting satellite. A pattern recognizer 420 detects the positions of CDM superframes for CDM channelization, and separates 32 channels from CDM frames.

A channel buffer 430 separately stores the 32 channels received from the pattern recognizer 420. Upon acquisition of one 25.5-msec TDM frame, a CDM modulator 440 receives the stored data from the channel buffer 430, processes the data by Pseudo-random-Noise (PN) spreading and channelization using a Walsh code, controls the gain of each channel, and combines the channels. Root-raised cosine (RRC) filters 450 filter CDM signals received from the CDM modulator 440. Digital to Analog (D/A) converters 460 convert the filtered signals from the RRC filters 450 from digital signals to analog signals. The converted analog signals are provided to up converter 465. Up converter 465 may comprise a central processing unit (CPU). After the signals are up converted to a radio frequency (RF), the RF signal is transmitted at a frequency of 2. gGHz to a terminal.

During the above operation, a clock generator 480 generates clock signals required for generation of the CDM signals using a reference clock signal received from the satellite tuner 410 through a Phase Locked Loop (PLL) 470.

A controller 490 provides control signals to all function blocks.

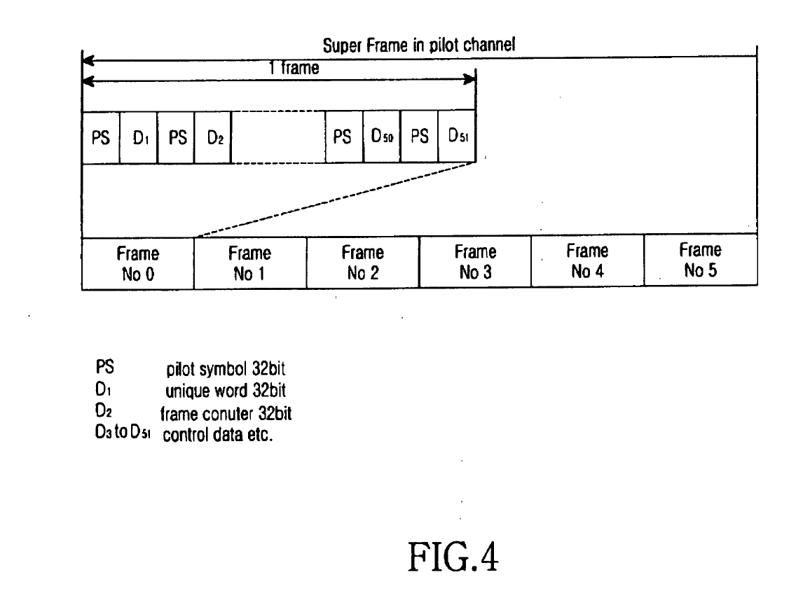

With reference to FIG. 4, the format of a frame output from the CDM modulator 440 will now be described. FIG. 4 is a diagram illustrating the structure of a pilot channel frame.

Referring to FIG. 4, one superframe includes six frames. In each frame, a 32-bit pilot symbol (PS) alternates with a 32-bit satellite broadcasting control data, that is, one of D₁ to D₅₁. The PS comprises all 0s. D₁ and D₂ denote a unique word and a frame counter, respectively. D₃ to D₅₀ are control data for a broadcasting channel. D₅₁ is reserved and thus empty of data.

In the embodiment of the present invention, therefore, the gap filler inserts a Gap Filler ID into the empty data area D₅₁ during the demodulation of a received satellite signal and the filling of data in a control channel. The transmission of the Gap Filler ID in an unused part of the existing control channel eliminates the need for an additional channel assignment.

The number of bits of the Gap Filler ID is determined according to a maximum number of gap fillers identifiable by a receiver. This depends on the layout of gap fillers by a gap filler designer and the transmit power of the gap fillers.

Thus, the gap filler illustrated in FIG. 3 further comprises a gap filler ID generator 495 for transmitting the Gap Filler ID in the 32-bit area among the 51 data areas alternating with the pilot symbol, in each frame of one control channel superframe.

Accordingly, when modulating a demodulated TDM signal into CDM signals and filling control channel data D₀ to D₅₀ in the control channel, the CDM modulator 440 inserts a 32-bit Gap Filler ID in one of the control channel data areas. To accomplish this, the gap filler ID generator 495 repeats the Gap Filler ID until it is 192 bits (32 bits per frame and thus 192 bits for six frames) for a superframe and inserts every 3 bits of the 192 bits into each of the frames of the control signal. The Gap Filler ID is inserted in the reserved control data area among the 51 control data areas. Alternatively, the Gap Filler ID can be transmitted in an arbitrary control data area through puncturing in a predetermined pattern.

The Gap Filler ID preferably is transmitted at least once for a superframe having six successive frames. The transmission of the Gap Filler ID starts with the first frame of the superframe. It has a value between 4 and 192. Since the Gap Filler ID is not encoded in the manner for processing D1 to D50 using Reed Solomon (RS) encoding, byte interleaving, and convolutional encoding, it is repeated over one superframe.

For example, if the Gap Filler ID is 32 bits, it occurs once every frame and thus occurs six times in one superframe. For a 64-bit Gap Filler ID, it occurs once every two frames and thus occurs three times in one superframe.

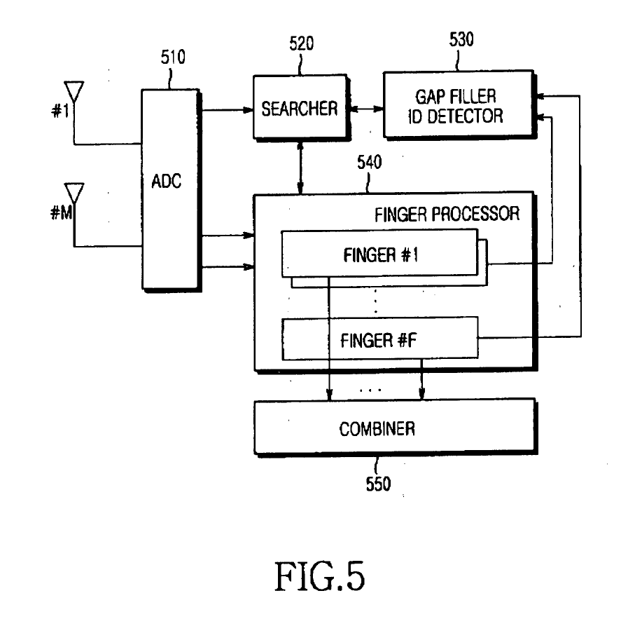

The structure of a receiving terminal for identifying a gap filler by its Gap Filler ID will now be described below with reference to FIG. 5.

Referring to FIG. 5, an analog-to-digital converter (ADC) 510 converts analog signals received from M paths to baseband digital signals and provides each of the path signals to a searcher 520 in a rake receiver. The searcher 520 measures the strengths of the path signals, detects effective paths from which signals have been received with strengths at or above a threshold, and assigns the effective paths to a finger processor 540. The finger processor 540 demodulates the signals received from the effective paths, respectively and outputs the demodulated symbols to a combiner 550. The combiner 550 combines the demodulated symbols, thereby estimating the original signal received from the paths.

A gap filler ID detector 530 selects a signal corresponding to a Gap Filler ID, starting from the first frame of a superframe in signals received from the finger processor 540, and accumulates the selected signal a predetermined number of times, thereby detecting the Gap Filler ID.

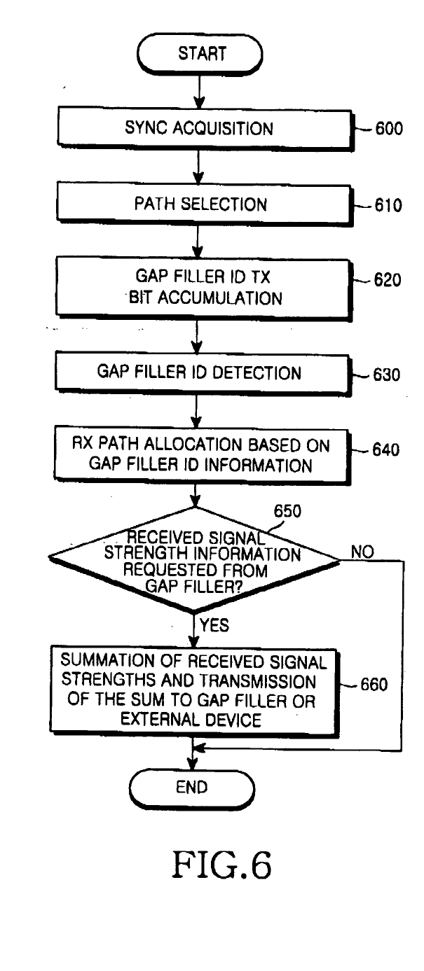

With reference to FIG. 6, the operation of the terminal for identifying a gap filler will now be described.

Referring to FIG. 6, the terminal acquires a spreading sync code, and frame and superframe synchronization by demodulating a Walsh code corresponding to a control channel in step 600. In step 610, the terminal searches multipath components around the timing at which initial synchronization is acquired and selects paths having power at or above a threshold. The terminal accumulates a value corresponding to a Gap Filler ID on the basis of the transmission bits of the Gap Filler ID for a predetermined number of frames beginning with the start point of a superframe, for each of the selected paths in step 620. The accumulation factor can be adjusted according to the state of a signal received from a corresponding path measured at the terminal and the number of bits of the Gap Filler ID. For example, if the Gap Filler ID is 32 bits and an accumulation period is six frames, a 32-bit symbol per frame is accumulated for six frames and then the final 32 bits are calculated.

After the accumulation, the terminal detects the Gap Filler ID based on the accumulated value for each path and stores the Gap Filler ID together with the received signal strength and timing for each path in step 630. Thus, the terminal detects the timing, received signal strengths, and Gap Filler IDs of all current effective multipaths.

Based on the detected information, the terminal assigns to the rake receiver paths having the strongest received signal strength from each gap filler, after that, the terminal assigns to the rake receiver paths in a descending order of received signal strength in step 640.

Upon a request for received signal strength information from a particular gap filler in step 650, the terminal sums the strengths of signals received from the gap filler and transmits the sum to the gap filler or an external device connected to the terminal in step 660.

The received signal strength information can be used for determining a shadow area and an overlap area in the gap filler.

The major advantages of the present invention are:
(1) The layout and transmit power of gap fillers can be optimized to allow a mobile receiver to measure interference between signals from gap fillers and shadow areas of the signals; and
(2) The receiver combines signals from a plurality of gap fillers, thus minimizing performance degradation caused by environmental changes during moving. That is, simultaneous reception of signals from as many gap fillers as possible prevents the environmental change-caused performance degradation during movement of the receiver.

While the invention has been shown and described with reference to a certain embodiment thereof, it should be understood by those skilled in the art that various changes in form and details may be made therein without departing from the spirit and scope of the invention as defined by the appended claims.

1. A gap filler for transmitting satellite broadcasting data received from a broadcasting satellite to a mobile receiver in a satellite broadcasting system, comprising:
a satellite tuner for demodulating the received satellite broadcasting signal;
a frame constructer for forming frames by modulating the demodulated satellite broadcasting signal, and inserting a gap filler identifier (ID) into a control channel frame; and
a radio processor for transmitting the frames received from the frame constructer at a radio frequency.

2. The gap filler of claim 1, wherein the frame constructer comprises:
a modulator for forming the frame by modulating the demodulated satellite broadcasting signal; and
a gap filler ID generator for inserting the gap filler ID in the control channel having broadcasting data channel information among signals output from the modulator.

3. The gap filler of claim 1, wherein the frame constructer inserts the gap filler ID in an empty area of the control channel frame.

4. The gap filler of claim 1, wherein a number of bits of the gap filler ID is determined according to a maximum number of gap fillers identifiable at the receiver.

5. A receiver for receiving a signal from a gap filler in a satellite broadcasting system, comprising:
a finger processor for demodulating signals received from paths having received signal strengths at or above a predetermined threshold; and
a gap filler identifier (ID) detector for detecting a gap filler ID from the demodulated symbols.

6. The receiver of claim 5, wherein the gap filler ID detector accumulates a signal corresponding to the gap filler ID a predetermined number of times.

7. The receiver of claim 5, wherein the finger processor demodulates signals having the strongest received signal strengths from each gap filler, based on gap filler IDs detected by the gap filler ID detector.

8. A method of converting satellite broadcasting data received from a broadcasting satellite and transmitting the converted satellite broadcasting data to a mobile receiver in a satellite broadcasting system, comprising the steps of:
receiving and demodulating the satellite broadcasting signal;
forming frames by modulating the demodulated satellite broadcasting signal, and inserting a gap filler identifier (ID) into a control channel frame; and
transmitting the frames at a radio frequency.

9. The method of claim 8, wherein the gap filler ID is inserted in an empty area of the control channel frame.

10. A method of identifying gap fillers from a received signal in a satellite broadcasting system, comprising the steps of:
acquiring superframe synchronization by demodulating a control channel received from a gap filler;
searching multipath components for timing at which initial synchronization is acquired and selecting paths having received signal strengths;
accumulating a value corresponding to a gap filler identifier (ID) in the control channel starting from the start point of a superframe, for each of the selected paths;
detecting gap filler IDs from the accumulated values; and
assigning, first of all, to fingers signals having the strongest received signal strengths from each gap filler, based on the detected gap filler IDs.
